(19) United States
(12) Patent Application Publication
(10) Pub. No.: US 2015/0348072 A1
(43) Pub. Date: Dec. 3, 2015

(54) METHOD AND SYSTEM FOR SELECTING A TARGET AUDIENCE

(71) Applicant: MASTERCARD INTERNATIONAL INCORPORATED, Purchase, NY (US)

(72) Inventors: Emma Goodyear, Wrexham (GB); Joanne Sterne, Chester (GB); Kent Olof Niklas Berntsson, Rye, NY (US); Adam Granoff, Greenwich, CT (US)

(73) Assignee: MASTERCARD INTERNATIONAL INCORPORATED, Purchase, NY (US)

(21) Appl. No.: 14/290,144

(22) Filed: May 29, 2014

(51) Int. Cl. G06Q 30/02; G06Q 20/20; G06Q 20/34; G06Q 20/10

(52) U.S. Cl. CPC G06Q 30/0204; G06Q 20/1085; G06Q 20/204; G06Q 20/34

(57) ABSTRACT

A method and a system are provided for selecting an audience of potential acceptors for receiving a targeted communication and for making a targeted communication to an audience of potential acceptors. The method involves retrieving, from one or more databases, a first set of information including checking account activities and characteristics attributable to an audience of checking account customers. At least a portion of the audience of checking account customers are identifiably associated with an audience of payment card holders. The method also involves retrieving, from one or more databases, a second set of information including payment card activities and characteristics attributable to the audience of payment card holders. Payment card holders meeting selection criteria are identified based on the first set of information and the second set of information. Payment card holders meeting the selection criteria are selected for receiving a targeted communication (e.g., a payment card upgrade).

### BACKGROUND OF THE DISCLOSURE

1. Field of the Disclosure

The present disclosure relates to a method and a system for selecting an audience of potential acceptors for receiving a targeted communication. The present disclosure also relates to a method and a system for making a targeted communication to an audience of potential acceptors. In particular, the present disclosure provides a method and a system for selecting an audience of payment card holders for receiving a targeted communication, based on checking account and associated payment card activities and characteristics.

2. Description of the Related Art

Direct mail marketing is a process by which a company or agency can advertise a product or service or a promotion directly to potential customers. For example, a bank in Venice, Fla. is planning a promotional campaign in order to increase customers. Since the bank is located in an area with a high population of retired people, it desires to specifically advertise banking promotions to prospective retired people in the Venice, Fla. area. Initially, the bank hires an advertising agency to produce a promotion flyer that can be sent to the prospective customers. The advertising agency designs the promotion flyer and gives the prototype to the bank.

Next, the bank hires a data mining agency to produce of list of retired people in the Venice, Fla. area. This list includes, for example, the name, age, address, and telephone number of the customer demographic that the bank requested.

Then, the bank hires a printing company to mass produce enough promotion flyers to be sent to prospective customers on the list. The printing company receives the promotion flyer produced by the advertising agency and mass produces the promotion flyer. The printing company can also fold and stuff the flyers in envelopes and address them. The bank can hire a separate mailing company to fold, stuff, and address the envelopes.

Finally, the bank hires a shipping company to ship the promotion flyers to the prospective customers. The shipping company can be any appropriate delivery service provider, such as the United States Postal Service (“USPS”). The prospective customers then receive the promotion flyers and possibly contact the bank based on the promotion flyers.

A direct mail marketing campaign is not limited to promotion flyers and letters for banks, but can also be used to disseminate catalogs, samples, and coupons to prospective customers. The direct mail marketing campaign can also be used to target existing customers as well as future customers. Furthermore, the companies utilizing direct mail marketing include retail companies selling products. Direct mail marketing can also be utilized by non-profit agencies, political campaigns, and lobby groups to distribute material regarding their causes to a population demographic.

The direct mail promotional campaign has the disadvantage that the bank or other company using the direct mail has no easy way to project the return on investment from the promotional campaign. In the bank example, the bank has no easy way to determine how much profit will be made by shipping the flyers. Moreover, since the advertising, printing, and shipping companies seek direct mail marketing business, these companies also desire to demonstrate the advantages of a direct mail promotional campaign. However, these companies have no way to easily advertise the advantages of using a direct mail promotional campaign to prospective mailers.

Therefore, a need exists for a system that can provide a more effective form of targeted marketing that is more personalized and relevant to the banking customer. A more holistic view of a banking customer's personal circumstances, including spending habits and preferences, is needed for effective targeted marketing. Further, a need exists for a system that can analyze a banking customer's personal circumstances and identify customer activities and circumstances that may represent an opportunity for a bank or other company to offer products or services or promotions to the customer that are specifically tailored to the customer, and communicate the offers to the customer.

### SUMMARY OF THE DISCLOSURE

The present disclosure provides an effective form of targeted marketing that is personalized and relevant to an entity, for example, a banking customer. In accordance with this disclosure, a more holistic view of a banking customer's personal circumstances, including spending habits and preferences, is assessed for effective targeted marketing. Also, in accordance with this disclosure, a method and a system are provided that can analyze a banking customer's personal circumstances and identify customer activities and circumstances that may represent an opportunity for a bank or other company to offer products or services or promotions to the customer that are specifically tailored to the customer, and communicate the offers to the customer.

The present disclosure also provides a method for selecting an audience of payment card holders for receiving a targeted communication. The method comprises retrieving, from one or more databases, a first set of information including checking account activities and characteristics attributable to an audience of checking account customers, at least a portion of the audience of checking account customers are identifiably associated with an audience of payment card holders; and retrieving, from one or more databases, a second set of information including payment card activities and characteristics attributable to the audience of payment card holders. The method also comprises identifying payment card holders meeting selection criteria based on the first set of information and the second set of information; and selecting payment card holders meeting the selection criteria for receiving a targeted communication.

The present disclosure further provides a method for making a targeted communication to an audience of payment card holders. The method comprises retrieving, from one or more databases, a first set of information including checking account activities and characteristics attributable to an audience of checking account customers, at least a portion of the audience of checking account customers are identifiably associated with an audience of payment card holders; and retrieving, from one or more databases, a second set of information including payment card activities and characteristics attributable to the audience of payment card holders. The method also comprises generating one or more payment card holder predictive behavioral segmentations based at least in part on the first set of information and the second set of information, and selecting payment card holders for receiving a targeted communication based on the one or more payment card holder predictive behavioral segmentations.

The present disclosure yet further provides a system for selecting an audience of payment card holders for receiving a targeted communication. The system comprises one or more databases configured to store a first set of information including checking account activities and characteristics attributable to an audience of checking account customers, at least a portion of the audience of checking account customers are identifiably associated with an audience of payment card holders; and one or more databases configured to store a second set of information including payment card activities and characteristics attributable to the audience of payment card holders. The system also comprises a processor configured to: identify payment card holders meeting selection criteria based on the first set of information and the second set of information; and select payment card holders meeting the selection criteria for receiving a targeted communication.

The present disclosure still further provides a system for making a targeted communication to an audience of payment card holders. The system comprises one or more databases configured to store a first set of information including checking account activities and characteristics attributable to an audience of checking account customers, at least a portion of the audience of checking account customers are identifiably associated with an audience of payment card holders; and one or more databases configured to store a second set of information including payment card activities and characteristics attributable to the audience of payment card holders. The system also comprises a processor configured to: generate one or more payment card holder predictive behavioral segmentations based at least in part on the first set of information and the second set of information; and select payment card holders for receiving a targeted communication based on the one or more payment card holder predictive behavioral segmentations.

The present disclosure also provides a method for generating one or more predictive behavioral segmentations. The method comprises retrieving, from one or more databases, a first set of information including checking account activities and characteristics attributable to an audience of checking account customers, at least a portion of the audience of checking account customers are identifiably associated with an audience of payment card holders; and retrieving, from one or more databases, a second set of information including payment card activities and characteristics attributable to the audience of payment card holders. The method also comprises analyzing the first set of information and the second set of information to determine behavioral information of the audience of payment card holders; extracting information related to an intent of the audience of payment card holders from the behavioral information; and generating one or more predictive behavioral segmentations based on the behavioral information and intent of the audience of payment card holders. The audience of payment card holders has a propensity to carry out certain activities based on the one or more predictive behavioral segmentations.

The present disclosure also provides a method for selecting an audience of payment card holders for receiving a targeted communication. The method comprises identifying a pool of checking account customers; removing premier relationship checking account customers from the pool of checking account customers; removing checking account customers not having a debit card from the pool of checking account customers; removing checking account customers using their checking account essentially as a money market deposit (checking) account (MMDP) from the pool of checking account customers; removing checking account customers having a checking account less than 6 months old from the pool of checking account customers; removing checking account customers having a payment card engagement behavior that comprises no POS activity, and an average monthly number of ATM withdrawals between 0 and about 0.25; removing checking account customers having a payment card capacity behavior that comprises an average monthly number of POS payment card transactions less than about 20, an average monthly number of ATM withdrawals between 0 and about 0.25, and average total monthly checking account debits between 0 and about $1000; restoring checking account customers having a checking account less than 6 months old to the pool of checking account customers; restoring premier relationship checking account customers to the pool of checking account customers; and identifying a resulting pool of mailable checking account customers.

These and other systems, methods, objects, features, and advantages of the present disclosure will be apparent to those skilled in the art from the following detailed description of the embodiments and the drawings.

### BRIEF DESCRIPTION OF THE DRAWINGS

FIG. 1 is a diagram of a four party payment card system.

FIG. 2 illustrates an exemplary dataset for the storing, reviewing, and/or analyzing of information used in identifying the selection criteria and generating predictive behavioral segmentations in accordance with the present disclosure.

FIG. 3 illustrates a payment card holder selection waterfall based on selection criteria in accordance with an exemplary embodiment of this disclosure.

FIG. 4 lists statistics for behavioral suppression (engagement) derived from the data in FIG. 3 in an exemplary embodiment of this disclosure.

FIG. 5 lists statistics for both behavioral suppression (engagement) and behavioral suppression (capacity) derived from the data in FIGS. 3 and 4 in an exemplary embodiment of this disclosure.

FIG. 6 is an illustrative cell structure derived from the data in FIG. 3 in an exemplary embodiment of this disclosure.

FIG. 7 is a table derived from data in FIG. 6 giving an overview of mailable cells 1-10, and blended mailable and non-mailable populations in an exemplary embodiment of this disclosure.

FIG. 8 is a flow chart illustrating a method for selecting an audience of payment card holders for receiving a targeted communication in an exemplary embodiment of this disclosure.

FIG. 9 is a flow chart illustrating a method for generating one or more predictive behavioral segmentations in an exemplary embodiment of this disclosure.

FIG. 10 is a flow chart illustrating a method for making a targeted communication to an audience of payment card holders in an exemplary embodiment of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, premier relationship checking accounts mean those checking accounts having added benefits over standard checking accounts. For example, added benefits of premier relationship checking accounts can include interest on the balance, no automatic teller machine (ATM) fees, no fee for checks, no monthly service charges, no charge for cashier's checks, travelers cheques, money orders, and stop payments; no charge for overdraft protection, and the like.

As used herein, entities that are identifiably associated are the same entity. For example, checking account customers identifiably associated with payment card holders are the same entities.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

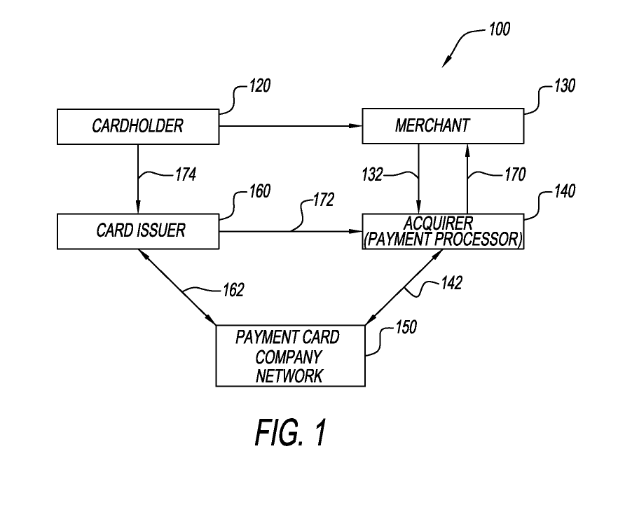

Referring to the drawings and, in particular, FIG. 1, there is shown a four party payment (credit, debit or other) card system generally represented by reference numeral 100. In card system 100, card holder 120 submits the payment card to the merchant 130. The merchant's point-of-sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt. A unique identification number can be used to protect any PII.

The account of the merchant 130 is credited, via 170, by the acquirer 140. The card issuer 160 pays, via 172, the acquirer 140. Eventually, the card holder 120 pays, via 174, the card issuer 160.

In accordance with the method of this disclosure, information that is stored in one or more databases can be retrieved (e.g., by a processor). The information can contain, for example, a first set of information including checking account activities and characteristics attributable to an audience of checking account customers. At least a portion of the audience of checking account customers are identifiably associated with an audience of payment card holders. Illustrative first set information can include, for example, financial (e.g., type of checking account, checking account with or without a debit card, checking account activity, and age of the checking account), demographic (e.g., age and gender), geographic (e.g., zip code and state or country of residence), and the like. Also, the information can contain, for example, a second set of information including payment card activities and characteristics attributable to the audience of payment card holders. Illustrative second set information can include, for example, financial (e.g., purchasing and payment information, payment card activity, POS payment card transaction activity, and ATM activity), demographic (e.g., age and gender), geographic (e.g., zip code and state or country of residence), and the like.

In an embodiment, all information stored in each database can be retrieved. In another embodiment, only a single entry in each of the one or more databases can be retrieved. The retrieval of information can be performed a single time, or performed multiple times. In an exemplary embodiment, only information pertaining to a specific payment card holder selection criteria or predictive behavioral segmentation is retrieved from each of the databases.

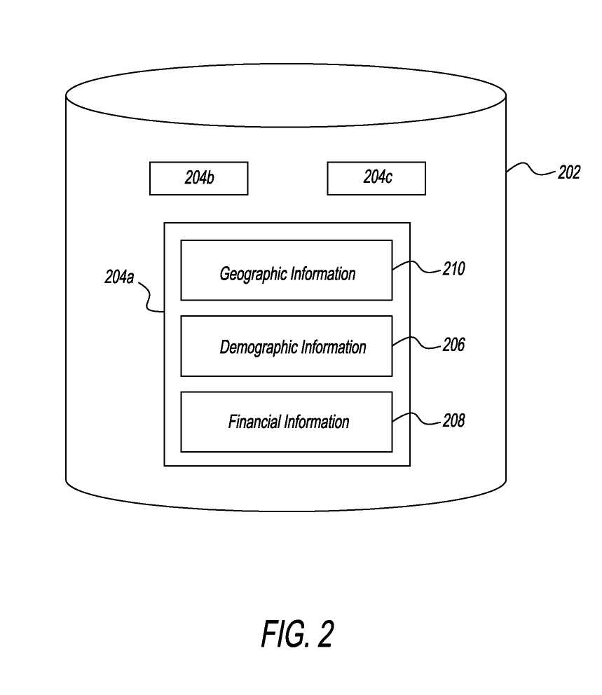

FIG. 2 illustrates an exemplary dataset 202 for the storing, reviewing, and/or analyzing of information used in identifying payment card holders meeting selection criteria and also in generating predictive behavioral segmentations. The dataset 202 can contain a plurality of entries (e.g., entries 204a, 204b, and 204c).

The demographic information 206 can include any demographic (e.g., age and gender) or other suitable information relevant to the particular application. In some embodiments, the geographic information 210 can include geographic (e.g., zip code and state or country of residence) or other suitable information relevant to the particular application. Suitable types of information relevant for identifying payment card holders meeting selection criteria and also generating predictive behavioral segmentations will be apparent to persons having skill in the relevant art. Likewise, the financial information 208 can include any financial information relevant to the particular application. For example, the financial information 208 can include financial information from the first set of information (e.g., type of checking account, checking account with or without a debit card, checking account activity, and age of the checking account), and from the second set of information (e.g., purchasing and payment information, payment card activity, POS payment card transaction activity, and ATM activity). A unique identification number can be used to protect any PII.

In an embodiment, this disclosure provides a method for selecting an audience of payment card holders for receiving a targeted communication. The method involves retrieving, from one or more databases, a first set of information including checking account activities and characteristics attributable to an audience of checking account customers. At least a portion of the audience of checking account customers are identifiably associated with an audience of payment card holders. The method also involves retrieving, from one or more databases, a second set of information including payment card activities and characteristics attributable to the audience of payment card holders. Based on the first set of information and the second set of information, payment card holders are identified meeting selection criteria. The method further involves selecting payment card holders meeting the selection criteria for receiving a targeted communication.

The method further involves identifying activities and characteristics attributable to the audience of payment card holders based on the selection criteria.

The selection criteria for payment card holders can be developed from the first set of information and the second set of information. Illustrative selection criteria include one or more of the following: (i) type of checking account; (ii) checking account with or without a debit card; (iii) checking account activity; (iv) age of the checking account; (v) payment card engagement behavior; and (vi) payment card capacity behavior.

In one example, the selection criteria comprise one or more of the following: (i) a premier relationship type of checking account; (ii) a checking account with a debit card; (iii) a checking account having activity greater than a MMDP account activity; (iv) a checking account age greater than about 6 months; (v) a payment card engagement behavior that comprises POS activity, and an average monthly number of ATM withdrawals greater than about 0.25; and (vi) a payment card capacity behavior that comprises an average monthly number of POS payment card transactions greater than about 20, an average monthly number of ATM withdrawals greater than about 0.25, and average total monthly checking account debits greater than about $1000. Payment card holders meeting the above selection criteria would likely be selected for receiving a targeted communication (e.g., a payment card upgrade). Based on the selection criteria, these payment card holders have a higher probability of increasing POS payment card transaction activity after receiving a payment card upgrade.

In another example, the selection criteria comprise one or more of the following: (i) a less than premier relationship type of checking account; (ii) a checking account without a debit card; (iii) a checking account having activity less than a MMDP account activity; (iv) a checking account age less than about 6 months; (v) a payment card engagement behavior that comprises no POS activity, and an average monthly number of ATM withdrawals between 0 and about 0.25; and (vi) a payment card capacity behavior that comprises an average monthly number of POS payment card transactions less than about 20, an average monthly number of ATM withdrawals between 0 and about 0.25, and average total monthly checking account debits between 0 and about $1000. Payment card holders meeting the above selection criteria would likely not be selected for receiving a targeted communication (e.g., a payment card upgrade). Based on the selection criteria, these payment card holders have a lower probability of increasing POS payment card transaction activity after receiving a payment card upgrade.

The method of this disclosure involves algorithmically analyzing the first set of information and the second set of information to identify payment card holders meeting selection criteria.

Referring to the selection criteria, the payment card engagement behavior comprises POS activity, and ATM withdrawal activity. In one example, the payment card engagement behavior comprises POS activity, and an average monthly number of ATM withdrawals greater than about 0.25. Payment card holders exhibiting this payment card engagement behavior have a higher probability of increasing POS payment card transaction activity after receiving a payment card upgrade. In another example, the payment card engagement behavior comprises no POS activity, and an average monthly number of ATM withdrawals between 0 and about 0.25. Payment card holders exhibiting this payment card engagement behavior have a lower probability of increasing POS payment card transaction activity after receiving a payment card upgrade.

Again, referring to the selection criteria, the payment card capacity behavior comprises POS activity, ATM withdrawal activity, and checking account debit activity. In one example, payment card capacity behavior comprises an average monthly number of POS payment card transactions greater than about 20, an average monthly number of ATM withdrawals greater than about 0.25, and average total monthly checking account debits greater than about $1000. Payment card holders exhibiting this payment card capacity behavior have a higher probability of increasing POS payment card transaction activity after receiving a payment card upgrade. In another example, payment card capacity behavior comprises an average monthly number of POS payment card transactions less than about 20, an average monthly number of ATM withdrawals between 0 and about 0.25, and average total monthly checking account debits between 0 and about $1000. Payment card holders exhibiting this payment card capacity behavior have a lower probability of increasing POS payment card transaction activity after receiving a payment card upgrade.

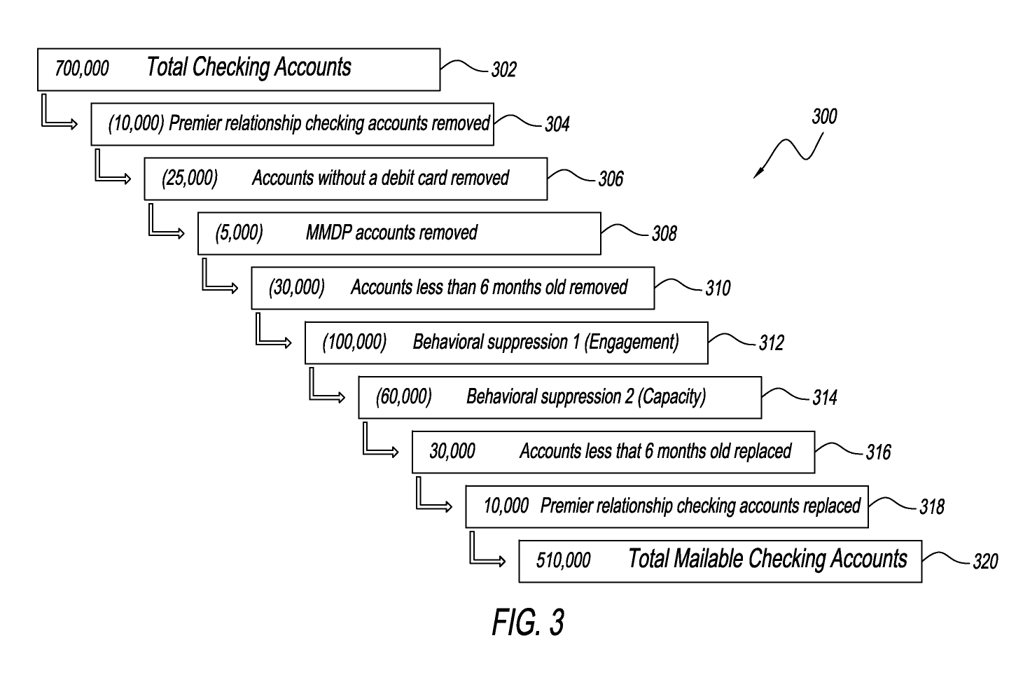

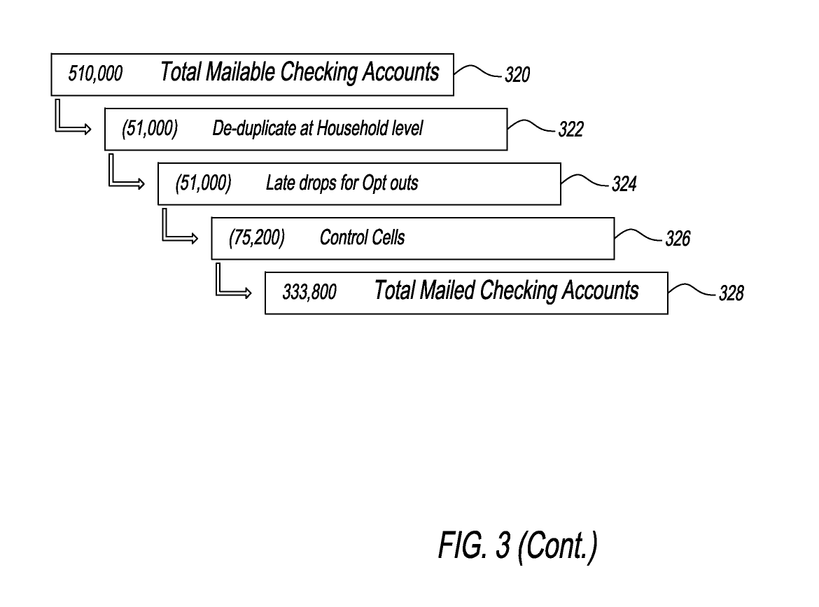

Referring to FIG. 3, an example of a payment card holder selection waterfall based on selection criteria is shown in accordance with an exemplary embodiment of this disclosure. The methodology shown in FIG. 3 can be applied to issuer card and account level data to optimize the audience selected for receiving a payment card upgrade mailer. In this example, the objective of the payment card upgrade is to increase POS payment card transaction activity. The data from the bank or issuer should be eligible accounts only and should exclude any accounts that the bank or issuer deems ineligible for a payment card upgrade.

In accordance with this selection method, identification of high priority accounts can be identified. These accounts can bypass rules based on selections criteria to ensure that they receive the promotional mailer. These accounts may include products or segments that the bank or issuer deems to be of strategic importance, and accounts that are too new to be assessed under the selection criteria. These accounts are ring fenced and all are selected for mailing.

Also, in accordance with this selection method, accounts that do not have the ability to increase POS payment card transaction usage are de-selected, for example, those accounts without a debit card.

In accordance with the selection method, accounts having payment card engagement behavior that are POS inactive (e.g., over a past number of months) with virtually no ATM withdrawals are de-selected. This low level of payment card usage is unlikely to be materially influenced with a non-incentivized campaign.

Similarly, accounts having a payment card capacity behavior that are low-medium POS usage with virtually no ATM withdrawals and low total checking account withdrawals are de-selected due to their low capacity to increase POS payment card usage. These accounts have virtually no ATM withdrawals and very few other withdrawals to migrate to POS transactions. These accounts are also crediting a low amount to their account monthly and so do not have capacity to increase their spend levels.

In accordance with the method of this disclosure, the depth of optimization will be dependent upon the bank or issuer's promotional mailing budget and the expected levels of performance uplift. Although a target mail volume will be set and these de-selections or suppressions will be cut accordingly, should there be additional high potential volume available beyond these cuts, a recommendation for expansion of the campaign will need to be considered by the bank or issuer.

With reference to the selection example shown in FIG. 3, a bank has upgraded their checking accounts from a standard to a premier relationship checking offering. They wish to communicate details of the upgrade to a portion of their checking accounts in order to drive increased spend whilst keeping mailing costs down. Such an upgrade could drive incremental improvements in activity, spend and other key performance indicators. The bank wishes to conduct a direct mail promotional campaign to about 330,000 (circa half) of the upgraded customers. The method of this disclosure is used to identify populations of accounts that are most likely to benefit from a targeted direct mailing in order to capitalize on their potential. The detailed analysis has been translated into a set of easy to implement rules in order for a bank or issuer to execute campaign selections.

Referring to the selection waterfall 300 depicted in FIG. 3, premier relationship checking account customers at 304 are removed or de-selected from the total checking accounts at 302. Although these customers will be added back subsequently, they are removed at the start of the exclusions waterfall in order to avoid suppressing volume. 100% of this population is replaced at 318.

Checking account customers without a debit card are removed or de-selected from the total checking accounts at 306. Many of these checking account customers are related to the MMDP customers at 308 and would therefore have been suppressed at 308. These customers are removed or de-selected as being unable to increase spend due to lack of a debit card.

MMDP account customers are removed or de-selected from the total checking accounts at 308. These accounts are generally money market deposit (checking) accounts and do not have any POS or ATM activity. Many of these checking account customers (e.g., about 80%) would have been suppressed lower down the waterfall at behavioral suppression 1 (engagement) at 312 and behavioral suppression 2 (capacity) at 314. These customers are removed or de-selected as being unable to increase spend due to lack of a debit card.

Checking account customers having accounts less than 6 months old are removed or de-selected from the total checking accounts at 310. These customers are removed at this stage in order to bypass the behavioral suppression 1 (engagement) at 312 and behavioral suppression 2 (capacity) at 314. These customers are replaced 100% lower down in the water fall at 316.

Checking account customers are removed or de-selected from the total checking accounts at behavioral suppression 1 (engagement) at 312 for a payment card engagement behavior that comprises no POS activity, and an average monthly number of ATM withdrawals between 0 and about 0.25. These accounts are excluded as they have been POS inactive for a defined time period (e.g., the past 5 months) and practically ATM inactive (e.g., average ATM withdrawal $2 per month). This low level of payment card usage is unlikely to be materially influenced with a non-incentivized campaign.

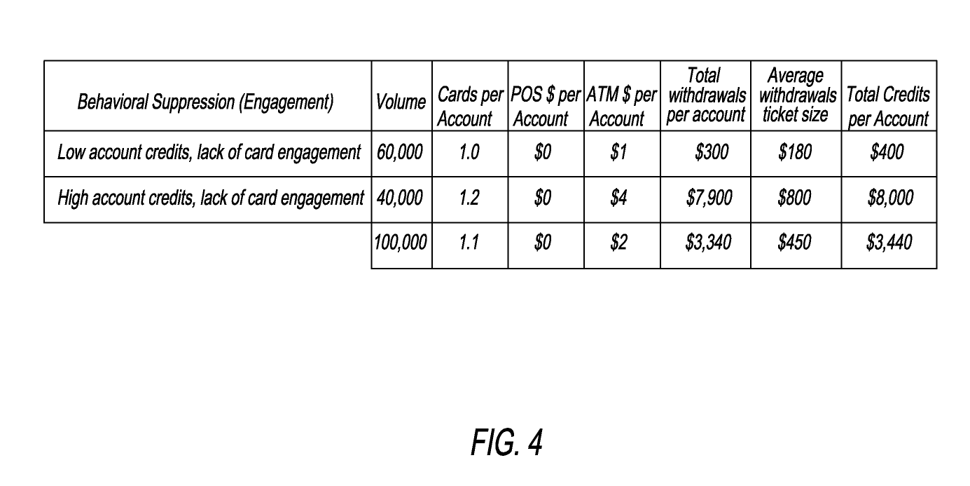

As shown in FIG. 4, over 50% of this population (100,000) are crediting on average about $400 per month to their account, with virtually no ATM or POS activity. The remainder of this population are crediting on average about $8,000 per month and withdrawals have a high ticket value of on average about $800 per month, with virtually no ATM or POS activity. These characteristics are potential indicators that these accounts are being used for the primary (and often sole) purpose of paying household bills. It is therefore going to be very difficult to shift this type of account to one highly engaged with a debit card and so these accounts are deemed unworthy of investing direct mail to these customers.

Checking account customers are removed or de-selected from the total checking accounts at behavioral suppression (capacity) at 314 for a payment card capacity behavior that comprises an average monthly number of POS payment card transactions less than about 20, an average monthly number of ATM withdrawals between 0 and about 0.25, and average total monthly checking account debits between 0 and about $1000. These accounts are excluded due to their low level of overall debits in conjunction with their existing high POS mix. This low level of payment card usage is unlikely to be materially influenced with a non-incentivized campaign.

Approximately 50% of this population are using their debit card for less than 5 transactions per month. The monthly ATM is about $4, and monthly credits are about $400. The low value of credits to the account materially impacts the customer's capacity to increase spend. In addition, there is virtually no ATM spend to migrate to POS and the customer is virtually debit card inactive. It is therefore unlikely these accounts can be influenced. The remaining 50% of this population have payment card usage already dominated by POS payment card transactions, and are crediting about $550 per month to their accounts. The low value of credits to the account, coupled with the already high POS usage, indicates that the customer is already using their debit card to spend what they are crediting to their account each month. Hence, they are unlikely to have capacity to increase spending.

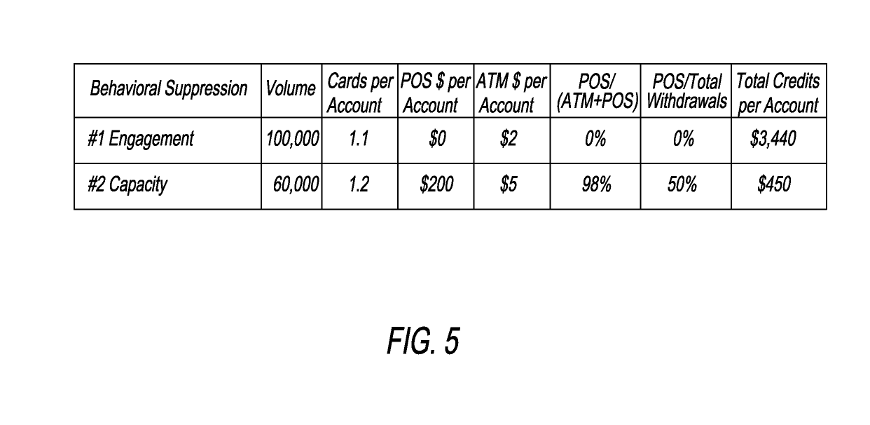

As shown in FIG. 5, statistics for both behavioral suppression (engagement) at 312 and behavioral suppression (capacity) at 314 are set forth.

At 316, checking account customers having accounts less than 6 months old that were removed or de-selected from the total checking accounts at 310 are replaced 100%. These customers were removed at 310 in order to bypass the behavioral suppression (engagement) at 312 and behavioral suppression (capacity) at 314.

At 318, the premier relationship checking account customers that were removed or de-selected from the total checking accounts at 304 are replaced 100%. They were removed at 304 in order to avoid suppressing volume. The total mailable checking accounts resulting from the above selection process are given at 320.

From the total mailable checking accounts at 320, further selection is conducted. At 322, household de-duplications are removed or de-selected from the total mailable checking accounts. About 10% of the volume is expected to be lost when de-duplicating at the household level. Household de-duplications should follow rules to ensure an optimized customer mailing.

The method of this disclosure provides illustrative rules for removal or drops if more than one customer has been selected from a single household. If there are multiple customers in the same household with a premier relationship checking account, do not remove any of those customers. If there are multiple premier relationship checking accounts for the same customer, retain the account with the highest dollar POS payment card transactions. If one or more customers hold premier relationship checking accounts, in addition to another account, remove the non-premier relationship checking accounts from the mailing. For multiple non-premier relationship checking accounts selected within the same household, remove the accounts with the highest existing mix of POS payment card transaction spend (measured as POS/[POS+ATM]).

From the total mailable checking accounts at 320, opt-outs at 324 are removed or de-selected from the total mailable checking accounts. Provision has been made in the method of this disclosure for late drops such as accounts that have opted out of receiving direct mail. The provision has been assumed to be about 10% of the total mailable checking account volume. This is applied to all cells including premier relationship checking accounts.

At 326, control cells are removed or de-selected from the total mailable checking accounts. Control cells are set to about 20% with the smallest control cell containing over 7,000 accounts. Post-campaign trend analysis, pre- and post-campaign results, as well as test versus control comparisons are included in the method of this disclosure.

At 328, the total mailed checking accounts (333,800) resulting from the selection criteria used in the method of this disclosure are given. As described above for this illustrative example, the bank wished to conduct a direct mail promotional campaign to about 330,000 potentially upgraded customers.

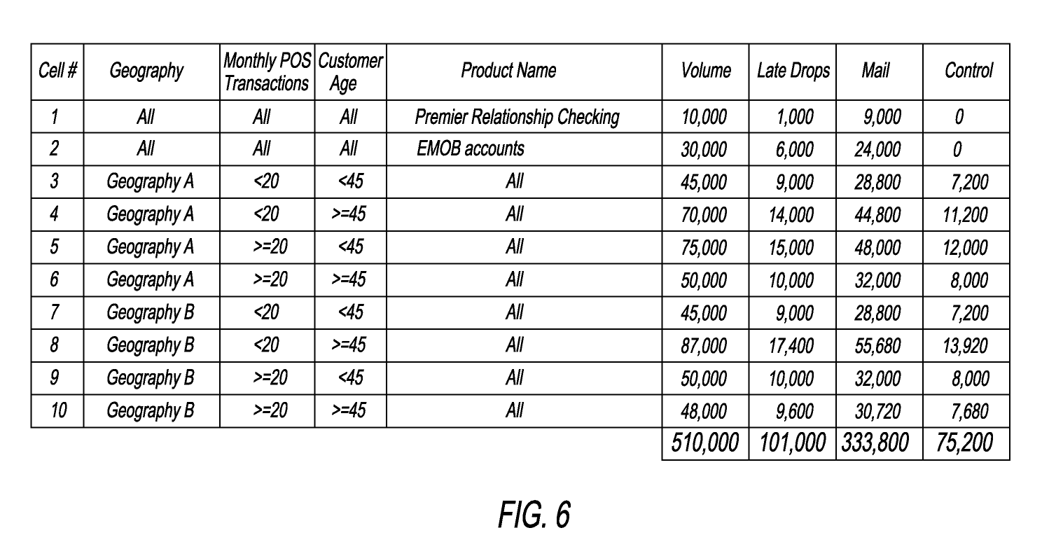

Referring to FIG. 6, an illustrative cell structure derived from the data in FIG. 3 is shown in an exemplary embodiment of this disclosure. The illustrative cells are structured to enable a read of results segmented by Geography A versus Geography B, customer age, and current POS engagement. Premier relationship checking accounts are in a standalone cell with no control to enable 100% mailing. Early months on books (recently acquired accounts) accounts (EMOB) are also included in a standalone cell.

The results in FIG. 6 show campaign performance split by geography, for example, Geography A versus Geography B (153,600 versus 147,200). Customer age is segmented to allow insights and engagement and potential adaptations to treatment, for example, age less than 45 versus age greater than or equal to 45 (137,600 versus 163,200). Current POS payment card transactions are segmented in order to gain insights and understanding by engagement level, for example, less than 20 POS transactions versus greater than or equal to 20 transactions (158,080 versus 142,720).

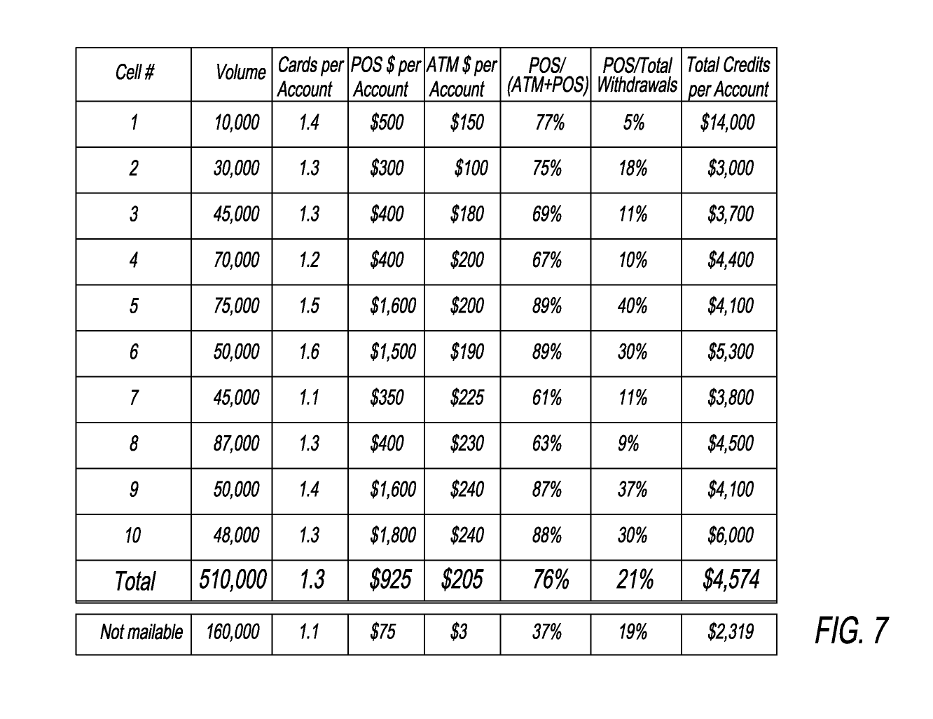

Referring to FIG. 7, a table derived from data in FIG. 6 is provided with an overview of mailable cells 1-10, and the blended mailable and non-mailable populations. The non-mailable cells are those that are excluded due to behavioral suppression (engagement) and behavioral suppression (capacity). The mailable cells are at a minimum level of POS engagement versus the non-mailable cells, with a large portion (e.g., over 50%) of the non-mailable accounts being POS inactive, and therefore less likely to change behavior due to the promotional mailing. The non-mailable accounts also show much lower ATM usage and lower monthly credits to the account.

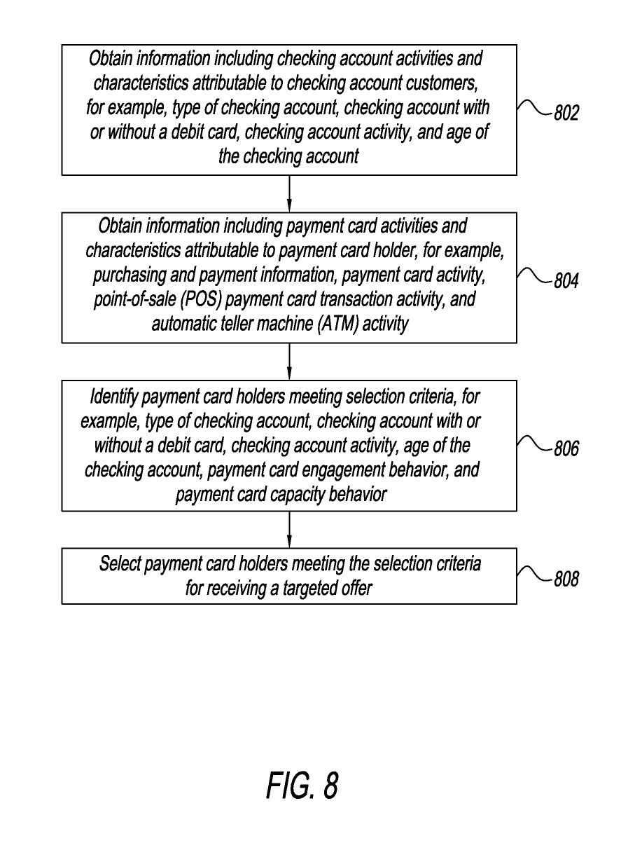

In an embodiment of this disclosure, a method is provided for selecting an audience of payment card holders for receiving a targeted communication. Referring to FIG. 8, the method involves retrieving at 802, from one or more databases, a first set of information including checking account activities and characteristics attributable to an audience of checking account customers. Illustrative first set information can include, for example, financial (e.g., type of checking account, checking account with or without a debit card, checking account activity, and age of the checking account), demographic (e.g., age and gender), geographic (e.g., zip code and state or country of residence), and the like. At least a portion of the audience of checking account customers are identifiably associated with an audience of payment card holders. The method also involves retrieving at 804, from one or more databases, a second set of information including payment card activities and characteristics attributable to the audience of payment card holders. Illustrative second set information can include, for example, financial (e.g., purchasing and payment information, payment card activity, POS payment card transaction activity, and ATM activity), demographic (e.g., age and gender), geographic (e.g., zip code and state or country of residence), and the like. Payment card holders meeting selection criteria based on the first set of information and the second set of information are identified at 806. Illustrative selection criteria for payment card holders can include one or more of the following: (i) type of checking account; (ii) checking account with or without a debit card; (iii) checking account activity; (iv) age of the checking account; (v) payment card engagement behavior; and (vi) payment card capacity behavior. Payment card holders meeting the selection criteria for receiving a targeted communication are selected at 808.

In another embodiment of this disclosure, one or more predictive behavioral segmentations are generated based at least in part on the first set of information from a financial entity (e.g., bank) and the second set of information from a financial entity (e.g., a financial transaction processing entity that is part of the payment card company network 150 of FIG. 1). Predictive behavioral segmentations can be selected based on the information obtained and stored in the one or more databases. The selection of information for representation in the predictive behavioral segmentations can be different in every instance. In one embodiment, all information stored in each database can be used for selecting predictive behavioral segmentations. In an alternative embodiment, only a portion of the information is used. The generation and selection of predictive behavioral segmentations may be based on specific criteria.

Predictive behavioral segmentations are generated from the information obtained from each database. The information is analyzed, extracted and correlated by, for example, a financial entity (e.g., a bank, a payment card company, and the like), and can include payment card holder financial information (e.g., the first set of information including type of checking account, checking account with or without a debit card, checking account activity, and age of the checking account, and the second set of information including purchasing and payment information, payment card activity, POS payment card transaction activity, and ATM activity), performing statistical analysis on financial information, finding correlations between financial information and customer behaviors, predicting future customer behaviors based on the financial information, relating information on a financial account with other financial accounts, or any other method of review suitable for the particular application of the data, which will be apparent to persons having skill in the relevant art. A unique identification number can be used to protect any PII.

The first set of information and the second set of information can be algorithmically analyzed, extracted and correlated to generate the predictive behavioral segmentations.

Activities and characteristics attributable to the audience of payment card holders based on the first set of information and the second set of information are identified. The audience of payment card holders has a propensity to carry out certain activities and to exhibit certain characteristics based on the one or more predictive behavioral segmentations generated from the first set of information and the second set of information. The activities and characteristics attributable to the audience of payment card holders and based on the first set of information and the second set of information are assessed to select payment card holders for receiving a targeted communication. This selection enables a targeted communication to be made to the audience of payment card holders. The transmittal can be performed by any suitable method as will be apparent to persons having skill in the relevant art.

Predictive behavioral segmentations can be defined based on geographical or demographical information, including but not limited to, age, gender, income, marital status, postal code, income, spending propensity, and familial status. In some embodiments, predictive behavioral segmentations can be defined by a plurality of geographical and/or demographical categories.

Predictive behavioral segmentations can also be based on behavioral variables. For example, the databases can store information relating to financial transactions. The information can be used to determine an individual's likeliness to use a payment card for POS transactions. For example, with respect to selection of payment card holders for receiving a targeted communication of a payment card upgrade, a payment card engagement behavior can include POS activity, and an average monthly number of ATM withdrawals greater than about 0.25. A payment card capacity behavior can include an average monthly number of POS payment card transactions greater than about 20, an average monthly number of ATM withdrawals greater than about 0.25, and average total monthly checking account debits greater than about $1000.

Also, for example, with respect to non-selection of payment card holders for receiving a targeted communication of a payment card upgrade, a payment card engagement behavior can include no POS activity, and an average monthly number of ATM withdrawals between 0 and about 0.25. A payment card capacity behavior can include an average monthly number of POS payment card transactions less than about 20, an average monthly number of ATM withdrawals between 0 and about 0.25, and average total monthly checking account debits between 0 and about $1000.

In an embodiment, the information retrieved from each of the databases can be analyzed to determine behavioral information of the audience of payment card holders. Also, information related to an intent of the audience of payment card holders can be extracted from the behavioral information. The predictive behavioral segmentations can be based upon the behavioral information of the audience of payment card holders and the intent of the audience of payment card holders. The predictive behavioral segmentations can be capable of predicting behavior and intent in the audience of payment card holders. The information retrieved from each of the databases can be algorithmically analyzed, extracted and correlated to generate the predictive behavioral segmentations.

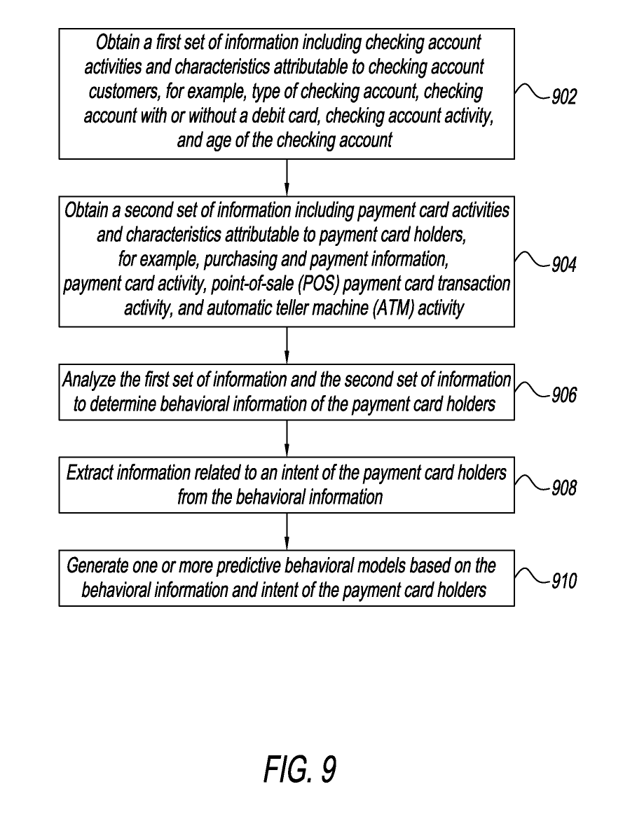

A method for generating one or more predictive behavioral segmentations is an embodiment of this disclosure. Referring to FIG. 9, the method involves retrieving at 902, from one or more databases, a first set of information including checking account activities and characteristics attributable to an audience of checking account customers. At least a portion of the audience of checking account customers are identifiably associated with an audience of payment card holders. The first set of information at 902 comprises financial (e.g., type of checking account, checking account with or without a debit card, checking account activity, and age of the checking account), demographic (e.g., age and gender), geographic (e.g., zip code and state or country of residence), and the like. The method also involves retrieving at 904, from one or more databases, a second set of information including payment card activities and characteristics attributable to the audience of payment card holders. The second set of information at 904 comprises financial (e.g., purchasing and payment information, payment card activity, POS payment card transaction activity, and ATM activity), demographic (e.g., age and gender), geographic (e.g., zip code and state or country of residence), and the like. The first set of information and the second set of information are analyzed at 906 to determine behavioral information of the one or more payment card holders. Information related to an intent at 908 of the one or more payment card holders is extracted from the behavioral information. One or more predictive behavioral segmentations are generated at 910 based on the behavioral information and intent of the one or more payment card holders. The one or more payment card holders have a propensity to carry out certain activities based on the one or more predictive behavioral segmentations (e.g., a propensity to increase POS payment card transaction activity after receiving a payment card upgrade).

In analyzing information to determine behavioral information, intent (audience) and other payment card member attributes are considered. Developing intent of audiences involves models that predict specific spend behavior in the future and desirable spend behaviors, in particular, POS payment card transaction spend behaviors.

The method further comprises assessing the activities and characteristics attributable to the one or more payment card holders based on the one or more predictive behavioral segmentations, to enable an entity to make a targeted communication to the audience of payment card holders. The one or more predictive behavioral segmentations are capable of predicting behavior and intent in the audience of payment card holders. The audience of payment card holders is people and/or businesses, the activities attributable to the audience of payment card holders are financial transactions associated with the payment card holders, and the characteristics attributable to the one or more payment card holders are demographics and/or geographical characteristics of the audience of payment card holders. The activities and characteristics attributable to the audience of payment card holders and based on the one or more predictive behavioral segmentations are assessed (e.g., algorithmically) to select payment card holders for receiving a targeted communication. This selection enables a targeted communication to be made to the audience of payment card holders.

A behavioral propensity ranking can be used for assessing the activities and characteristics attributable to the audience of payment card holders based on the one or more predictive behavioral segmentations. The behavioral propensity ranking is used to rank the behavioral segments by those most likely to exhibit a certain behavior.

An entity can analyze the generated predictive behavioral segmentations (e.g., by analyzing the stored data for each entity comprising the predictive behavioral segmentation) for behavioral information (e.g., spend behaviors and propensities). In some embodiments, the behavioral information can be represented by a behavioral propensity score. Behavioral information can be assigned to each corresponding predictive behavioral segmentation, or can be assigned to an audience of predictive behavioral segmentations.

Predictive behavioral segmentations or behavioral information can be updated or refreshed at a specified time (e.g., on a regular basis or upon request of a party). Updating predictive behavioral segmentations can include updating the entities included in each predictive behavioral segmentation with updated demographic data and/or updated financial data. Predictive behavioral segmentations can also be updated by changing the attributes that define each predictive behavioral segment, and generating a different set of behaviors. The process for updating behavioral information can depend on the circumstances regarding the need for the information itself.

Although the above methods and processes are disclosed primarily with reference to financial data and spending behaviors, it will be apparent to persons having skill in the relevant art that the predictive behavioral segmentations can be beneficial in a variety of other applications. Predictive behavioral segmentations can be useful in the evaluation of customer data that may need to be protected.

For instance, predictive behavioral segmentations can have useful applications in measuring the effectiveness of advertising or other consumer campaigns. A party can desire to discover the effectiveness of a particular advertising or promotional campaign in reaching a specific set of consumers.

For example, a bank may want to know the effectiveness of a promotional campaign initiated by the bank and directed towards customers that may want to upgrade their payment cards. The bank can identify predictive behavioral segmentations and summarize relevant spend behaviors (e.g., POS payment card transaction spend behaviors) for the identified predictive behavioral segmentations. Summary of the relevant spend behaviors (e.g., showing an increase or decrease in POS payment card transactions) for each predictive behavioral segmentation (e.g., including the predictive behavioral segmentations of ideal consumers) can be provided to the bank.

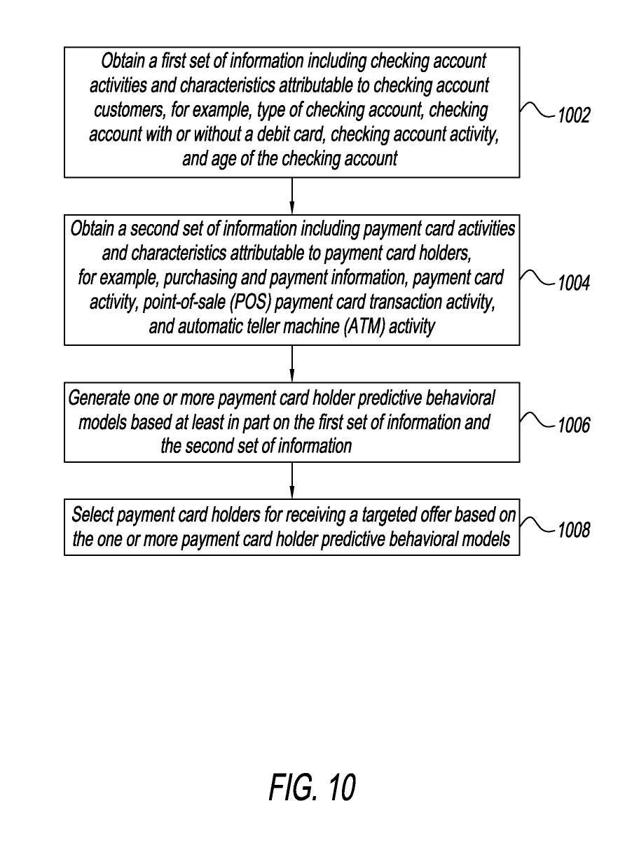

FIG. 10 illustrates an exemplary method for making a targeted communication (e.g., promotion for payment card upgrade) by a bank or a payment card issuer (the payment card issuer 160 in FIG. 1) to an audience of potential acceptors (i.e., payment card holders). In step 1002, an entity (e.g., a financial transaction processing entity that is part of the payment card company network 150 of FIG. 1) retrieves, from one or more databases a first set of information including checking account activities and characteristics attributable to an audience of checking account customers. At least a portion of the audience of checking account customers are identifiably associated with an audience of payment card holders. In step 1004, the entity retrieves, from one or more databases, a second set of information including payment card activities and characteristics attributable to the audience of payment card holders.

The entity analyzes the first set of information and second set of information to determine behavioral information of the audience of potential acceptors. The entity extracts information related to intent of the audience of potential acceptors from the behavioral information.

In step 1006, based on at least one of selected activities criteria and selected characteristics criteria from the first set of information and second set of information, including behavioral information and intent of the audience of potential acceptors, a plurality of predictive behavioral segmentations are generated. The entity generates predictive behavioral segmentations based on the first set of information and the second set of information, and identifies activities and characteristics attributable to potential acceptors based on the predictive behavioral segmentations. Activities and characteristics attributable to the audience of potential acceptors are identified based on the one or more predictive behavioral segmentations. The audience of potential acceptors has a propensity to carry out certain activities and to exhibit certain characteristics based on the one or more predictive behavioral segmentations.

The activities and characteristics attributable to the audience of potential acceptors and based on the one or more predictive behavioral segmentations are assessed to select payment card holders for receiving a targeted communication. This selection enables a targeted communication to be made to the audience of payment card holders. In an embodiment, a behavioral propensity ranking is assigned to the potential acceptors based on the predictive behavioral segmentations. The ranking is indicative of a propensity of a potential acceptor to exhibit a certain behavior.

The predictive behavioral segmentations are used to predict behavior and intent in an audience of potential acceptors (e.g., the above predictive behavioral segmentation examples are used to predict individuals likely to increase POS payment card transactions after receiving a payment card upgrade). At 1008, payment card holders are selected for receiving a targeted communication based on the one or more payment card holder predictive behavioral segmentations. The bank executes promotions to targeted potential acceptors through their mobile channel or e-mail or by direct mail.

In an embodiment, the bank provides feedback to an associated entity (e.g., the financial transaction processing entity or payment card company) to enable the associated entity to monitor and track impact of targeted communications. This “closed loop” system allows the bank and associated entities to track promotional campaigns, measure efficiency of the targeting, and make any improvements for the next round of campaigns.

One or more algorithms can be employed to determine formulaic descriptions of the assembly, analysis, extraction, and correlation of the first set of information and the second set of information, using any of a variety of known mathematical techniques. These formulas in turn can be used to derive or generate one or more predictive behavioral segmentations using any of a variety of available trend analysis algorithms.

Thus, apparatus, systems, methods and computer program products are herein disclosed to identify payment card holder selection criteria, generate predictive behavioral segmentations, to identify, analyze, extract and correlate banking customer activities and characteristics that represent an opportunity to target offer products or services or promotions to the customer and for communicating the target offers to the customer, and also an opportunity for predicting customer behavior and intent. Embodiments of the present disclosure will leverage the information available to identify data that is indicative of a customer's banking activities and characteristics and to predict customer behavior and intent based on those activities and characteristics. Such activities and characteristics can include, but are not limited to, spending behavior, checking account activity, debit account activity, payment card engagement behavior as described herein, payment card capacity behavior as described herein, and the like. By identifying and analyzing customer activities and characteristics, payment card holder selection criteria can be identified, predictive behavioral segmentations can be generated, and one can offer products and services and promotions that are relevant to the customer's needs or desires.

In accordance with the present disclosure, information is matched on an anonymous basis by linking checking account information with purchase card transaction information. For example, an identification number is associated with the first set of information (i.e., checking account information) that is conveyed from a banking entity to a financial transaction processing entity to protect personally identifiable information (PII). This PII can be matched anonymously with payment card transaction data by the financial transaction processing entity.

It will be understood that the present disclosure may be embodied in a computer readable non-transitory storage medium storing instructions of a computer program which when executed by a computer system results in performance of steps of the method described herein. Such storage media may include any of those mentioned in the description above.

Where methods described above indicate certain events occurring in certain orders, the ordering of certain events may be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for selecting an audience of payment card holders for receiving a targeted communication, said method comprising:
retrieving, from one or more databases, a first set of information including checking account activities and characteristics attributable to an audience of checking account customers, wherein at least a portion of the audience of checking account customers are identifiably associated with an audience of payment card holders;
retrieving, from one or more databases, a second set of information including payment card activities and characteristics attributable to the audience of payment card holders;
identifying payment card holders meeting selection criteria based on the first set of information and the second set of information; and
selecting payment card holders meeting the selection criteria for receiving a targeted communication.

2. The method of claim 1, further comprising identifying activities and characteristics attributable to the audience of payment card holders based on the first set of information and the second set of information.

3. The method of claim 1, wherein the selection criteria for payment card holders comprise one or more of the following: (i) type of checking account; (ii) checking account with or without a debit card; (iii) checking account activity; (iv) age of the checking account; (v) payment card engagement behavior; and (vi) payment card capacity behavior.

4. The method of claim 3, wherein the selection criteria comprise one or more of the following: (i) a premier relationship type of checking account; (ii) a checking account with a debit card; (iii) a checking account having activity greater than a money market deposit (checking) account (MMDP) activity; (iv) a checking account age greater than about 6 months; (v) a payment card engagement behavior that comprises POS activity, and an average monthly number of ATM withdrawals greater than about 0.25; and (vi) a payment card capacity behavior that comprises an average monthly number of POS payment card transactions greater than about 20, an average monthly number of ATM withdrawals greater than about 0.25, and average total monthly checking account debits greater than about $1000.

5. The method of claim 3, wherein the selection criteria comprise one or more of the following: (i) a less than premier relationship type of checking account; (ii) a checking account without a debit card; (iii) a checking account having activity less than a MMDP account activity; (iv) a checking account age less than about 6 months; (v) a payment card engagement behavior that comprises no POS activity, and an average monthly number of ATM withdrawals between 0 and about 0.25; and (vi) a payment card capacity behavior that comprises an average monthly number of POS payment card transactions less than about 20, an average monthly number of ATM withdrawals between 0 and about 0.25, and average total monthly checking account debits between 0 and about $1000.

6. The method of claim 1, further comprising algorithmically analyzing the first set of information and the second set of information to identify and select payment card holders meeting selection criteria.

7. The method of claim 1, wherein the targeted communication comprises a payment card upgrade.

8. The method of claim 7, wherein the selected payment card holders have a propensity to change their POS payment card transaction activity behavior after receiving the payment card upgrade.

9. The method of claim 3, wherein payment card engagement behavior comprises POS activity and ATM withdrawal activity.

10. The method of claim 3, wherein payment card engagement behavior comprises (i) no POS activity and an average monthly number of ATM withdrawals between 0 and about 0.25; or (ii) POS activity and an average monthly number of ATM withdrawals greater than about 0.25.

11. The method of claim 3, wherein payment card capacity behavior comprises POS activity, ATM withdrawal activity, and checking account debit activity.

12. The method of claim 3, wherein payment card capacity behavior comprises (i) an average monthly number of POS payment card transactions less than about 20, an average monthly number of ATM withdrawals between 0 and about 0.25, and average total monthly checking account debits between 0 and about $1000; or (ii) an average monthly number of POS payment card transactions greater than about 20, an average monthly number of ATM withdrawals greater than about 0.25, and average total monthly checking account debits greater than about $1000.

13. A system for selecting an audience of payment card holders for receiving a targeted communication, said system comprising:
one or more databases configured to store a first set of information including checking account activities and characteristics attributable to an audience of checking account customers, wherein at least a portion of the audience of checking account customers are identifiably associated with an audience of payment card holders;
one or more databases configured to store a second set of information including payment card activities and characteristics attributable to the audience of payment card holders;
a processor configured to:
identify payment card holders meeting selection criteria based on the first set of information and the second set of information; and
select payment card holders meeting the selection criteria for receiving a targeted communication.

14. The system of claim 13, wherein the processor further configured to:
identify activities and characteristics attributable to the audience of payment card holders based on the first set of information and the second set of information.

15. The system of claim 13, wherein the selection criteria for payment card holders comprise one or more of the following: (i) type of checking account; (ii) checking account with or without a debit card; (iii) checking account activity; (iv) age of the checking account; (v) payment card engagement behavior; and (vi) payment card capacity behavior.

16. The system of claim 13, wherein the processor further configured to:
algorithmically analyze the first set of information and the second set of information to identify and select payment card holders meeting selection criteria.

17. The system of claim 13, wherein the targeted communication comprises a payment card upgrade.

18. The system of claim 17, wherein the selected payment card holders have a propensity to change their POS payment card transaction activity behavior after receiving the payment card upgrade.

19. The system of claim 15, wherein payment card engagement behavior comprises POS activity and ATM withdrawal activity.

20. The system of claim 15, wherein payment card capacity behavior comprises POS activity, ATM withdrawal activity, and checking account debit activity.
